(19) United States
(12) Patent Application Publication
(10) Pub. No.: US 2006/0154132 A1
(43) Pub. Date: Jul. 13, 2006

(54) Fuel-cell-equipped apparatus and fuel cartridge

(75) Inventor: Atsushi Misawa, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/325,500

(22) Filed: Jan. 5, 2006

(30) Foreign Application Priority Data
Jan. 13, 2005 (JP) 2005-006788

(51) Int. Cl. H01M 8/04

(52) U.S. Cl. 429/34; 429/23

(57) ABSTRACT

The present invention provides a fuel-cell-equipped apparatus equipped with a fuel cell, comprising: a holding part which holds a fuel cartridge in which a fuel that is supplied to the fuel cell is sealed, wherein the holding part is capable of being in a first holding state holding the fuel cartridge in a position incapable of supplying the fuel to the fuel cell, and being in a second holding state holding the fuel cartridge in a position capable of supplying the fuel to the fuel cell, in order to solve the problem that the fuel-cell-equipped apparatuses become large in size by the amount of the spaces for them.

### BACKGROUND OF THE INVENTION

1. Field of the Invention

The present invention relates to a fuel-cell-equipped apparatus and a fuel cartridge, and particularly relates to an apparatus equipped with a fuel cell such as a direct methanol fuel cell using a methanol solution (fuel), and a fuel cartridge in which the fuel is sealed.

2. Description of the Related Art

A fuel-cell-equipped apparatus in which a fuel cell is mounted on a portable electronic apparatus such as a digital camera, and a camera-equipped portable telephone to drive the portable electronic apparatus by electric power obtained from the fuel cell is known (for example, Japanese Patent Application Laid-Open No. 2004-355871).

As the fuel cell which is mounted on such a portable electronic apparatus, a direct methanol fuel cell which supplies a methanol solution being the fuel to a fuel electrode (anode) of the fuel cell and supplies oxygen to an air electrode (cathode) of the fuel cell, and thereby obtains electric power via an electrolyte membrane such as a proton conductive membrane is known.

Besides, a portable electronic apparatus which includes a fuel pack and a sub pack in a digital camera equipped with a fuel cell, and supplies a fuel sealed in these packs to the fuel cell by a driving force of a pump provided at the digital camera is proposed (for example, Japanese Patent Application Laid-Open No. 2004-139742). Further, a portable apparatus which has a delivery pump incorporated therein and supplies a fuel in a fuel cartridge to a fuel cell by a driving force of the delivery pump is proposed (for example, Japanese Patent Application Laid-Open No. 2004-119027).

### SUMMARY OF THE INVENTION

However, the above described conventional portable electronic apparatuses which supply the fuel sealed in the packs and the fuel cartridges to the fuel cells by the pumps have the disadvantage that since they have the pumps incorporated in the apparatus bodies, they are large in size and heavy in weight, and thus they are unsuitable for being carried.

Since in the conventional fuel-cell-equipped apparatuses, the packs and the fuel cartridges are held in the same locations, it cannot be visually checked whether the held packs and fuel cartridges are in the state before the fuel is supplied or in the state where the fuel is supplied, thus causing the problem of replacing the pack before supply with a new pack, and removing the pack under supply from the holding part.

Furthermore, the conventional fuel-cell-equipped apparatuses hold the packs and the fuel cartridges, and therefore, they have the problem that the fuel-cell-equipped apparatuses become large in size by the amount of the spaces for them.

The present invention is made in view of the above circumstances, and has an object to provide a fuel-cell-equipped apparatus which is compact and light in weight and can visually recognize a state of a fuel cartridge, and the fuel cartridge suitable for this.

In order to achieve the above described object, the invention of a first aspect is, in a fuel-cell-equipped apparatus equipped with a fuel cell, characterized by including a holding part which holds a fuel cartridge in which a fuel that is supplied to the fuel cell and compressed air are sealed.

According to the fuel-cell-equipped apparatus of the first aspect, the holding part which holds the fuel cartridge in which the fuel that is supplied to the fuel cell and the compressed air are sealed is provided. When the fuel sealed in the fuel cartridge is supplied to the fuel cell of the portable electronic apparatus after the fuel cartridge is held in this holding part, the fuel is supplied by being rapidly pumped by the pressure of the compressed air also sealed in the fuel cartridge. Thereby, the fuel can be supplied to the fuel cell without providing a pump, and therefore, a compact and light fuel-cell-equipped apparatus can be provided. Besides, a reserve fuel cartridge can be held in the above described holding part.

In order to achieve the above described object, the invention according to a second aspect is, in a fuel-cell-equipped apparatus equipped with a fuel cell, characterized by including a holding part which holds a fuel cartridge in which a fuel that is supplied to the fuel cell is sealed, and characterized in that the holding part is capable of being in a first holding state holding the fuel cartridge in a position incapable of supplying the fuel to the fuel cell, and being in a second holding state holding the fuel cartridge in a position capable of supplying the fuel to the fuel cell.

According to the invention described in the second aspect, the holding part of the fuel cartridge is constructed to be able to be in the first holding state holding the fuel cartridge in the position incapable of supplying the fuel to the fuel cell and in the second holding state holding the fuel cartridge in the position capable of supplying the fuel to the fuel cell, and therefore, the state of the fuel-cell-equipped apparatus can be visually recognized.

In order to achieve the above described object, the invention according to a third aspect is, in a fuel-cell-equipped apparatus equipped with a fuel cell, characterized by including a holding part which holds a fuel cartridge in which a fuel that is supplied to the fuel cell is sealed, and characterized in that the holding part is provided in a hinge part of the fuel-cell-equipped apparatus.

According to the invention of the third aspect, the holding part of the fuel cartridge is provided in the hinge part which is a dead space of the fuel-cell-equipped apparatus, and therefore, the fuel cartridge can be held without increasing the fuel-cell-equipped apparatus in size.

The invention according to a fourth aspect is, in the invention of the first, second and third aspects, characterized by further including a control unit which causes a display part to indicate that the fuel cartridge is required to be held to the holding part when the fuel in the fuel cell lowers from a predetermined amount, and causes the display part to indicate that the fuel of the fuel cartridge is supplied to the fuel cell when the fuel in the fuel cell lowers from an amount required at generating electrical power.

According to the invention of the fourth aspect, it is indicated in the display part that the fuel cartridge is required to be held to the holding part when the fuel in the fuel cell lowers from a predetermined amount, and it is indicated in the display part that the fuel in the fuel cartridge is supplied to the fuel cell when. Therefore, an insertion operation of the fuel cartridge into the holding part, and the fuel supply operation of the fuel cartridge can be smoothly performed.

Also, the invention according to a fourth aspect is, in the invention of the first, second and third aspects, characterized by further including a control unit which causes a display part to indicate that the fuel cartridge is required to be held to the holding part when generated voltage of the fuel cell lowers from a predetermined voltage, and causes the display part to indicate that the fuel of the fuel cartridge is supplied to the fuel cell when the generated voltage of the fuel cell lowers from a limit voltage.

According to the invention of the fourth aspect, it is indicated in the display part that the fuel cartridge is required to be held to the holding part when the generated voltage of the fuel cell lowers from the predetermined voltage, and it is indicated in the display part that the fuel in the fuel cartridge is supplied to the fuel cell when the generated voltage of the fuel cell lowers from a limit voltage.

The invention according to a fifth aspect is, in the invention of the first, second and third aspects, characterized in that a fuel supply section is provided at the holding part of the fuel-cell-equipped apparatus, and the fuel in the fuel cartridge is supplied to the fuel cell by the fuel supply section.

According to the fuel-cell-equipped apparatus of the fifth aspect, the fuel of the fuel cartridge is supplied to the fuel cell via the fuel supply section by the pressure of the compressed air.

The invention according to a sixth aspect is, in the invention of the fifth aspect, characterized in that a fuel feeding pipe is provided at the fuel supply section of the fuel-cell-equipped apparatus, and a base end portion of the fuel feeding pipe is allowed to communicate with the fuel cell and a sharpened part which pierces the fuel cartridge is formed at a tip end portion of the fuel feeding pipe.

According to the fuel-cell-equipped apparatus of the sixth aspect, when the fuel cartridge is pushed in by being held in the holding part, by this operation, the fuel cartridge is pierced by the sharpened part of the fuel feeding pipe provided at the fuel supply section, and therefore, the fuel in the fuel cartridge is supplied to the fuel cell via the fuel feeding pipe. Thereby, with the extremely simple structure, the fuel in the fuel cartridge can be supplied to the fuel cell.

The invention according to a seventh aspect is, in the fuel cartridge which is used for the fuel-cell-equipped apparatus of the second aspect, characterized in that a first positioning portion for positioning the fuel cartridge in the first holding state, and a second positioning portion for positioning the fuel cartridge in the second holding state are formed.

According to the fuel-cell-equipped apparatus of the seventh aspect, when the fuel cartridge is in the first holding state, the fuel cartridge is positioned in the first holding state by the first positioning portion formed in itself, and is positioned in the second holding state by the second positioning portion formed in itself. Therefore, the fuel cartridge is reliably positioned in the first holding state and the second holding state.

According to the invention described in an eighth aspect, the fuel cartridge is, in the fuel cartridge which is used for the fuel-cell-equipped apparatus of the sixth aspect, characterized in that the fuel cartridge is constructed by a rigid portion and an elastic portion, and the sharpened part of the fuel feeding pipe pierces the elastic portion.

According to the fuel cartridge described in the eighth aspect, by making the portion pierced by the sharpened part of the fuel feeding pipe described in the sixth aspect the elastic portion, it can be easily pierced by the sharpened part, and after being pierced, the elastic portion closely contacts the outer peripheral surface of the fuel feeding pipe by the elastic restoring force of the elastic portion. Therefore, leakage of the fuel can be prevented. By making the other portion the rigid portion, rigidity can be given to the fuel cartridge.

According to the invention described in a ninth aspect, in the fuel cartridge which is used for the fuel-cell-equipped apparatus of the sixth aspect, the fuel cartridge is characterized in that the fuel cartridge is constructed to be of a double bag body structure, the fuel is sealed in an inner bag body, and compressed air which applies pressure to the inner bag body is sealed in an outer bag body.

According to the fuel cartridge described in the ninth aspect, the fuel is sealed in the inner bag body and the compressed air which applies the pressure to the inner bag body is sealed in the outer bag body, whereby when the sharpened part of the fuel feeding pipe described in the sixth aspect pierces the fuel cartridge, the fuel sealed in the inner bag body is pushed out into the fuel feeding pipe and supplied by the pressure of the compressed air which is sealed in the outer bag body. By separately preparing the bag bodies in which the fuel and the compressed air are sealed as above, the pressure of the compressed air in the outer bag body can be applied to the surface of the inner bag body substantially uniformly, and therefore, reliability of refueling is enhanced.

As described above, according to the fuel-cell-equipped apparatus of the present invention, the holding part which holds the fuel cartridge in which the fuel which is supplied to the fuel cell and the compressed air are sealed is provided, and the fuel can be supplied to the fuel cell without providing a pump. Therefore, a compact and light fuel-cell-equipped apparatus can be provided.

Besides, according to the fuel-cell-equipped apparatus of the present invention, the holding part of the fuel cartridge is constructed to be capable of being in the first holding state holding the fuel cartridge in the position incapable of supplying the fuel to the fuel cell and in the second holding state holding the fuel cartridge in the position capable of supplying the fuel to the fuel cell, and therefore, the state of the fuel-cell-equipped apparatus can be visually recognized.

Further, according to the fuel-cell-equipped apparatus of the present invention, the holding part of the fuel cartridge is provided in the hinge part which is the dead space of the fuel-cell-equipped apparatus, and therefore; the fuel cartridge can be held without increasing the fuel-cell-equipped apparatus in size.

According to the fuel cartridge of the present invention, the fuel cartridge is positioned in the first holding state by the first positioning portion formed in itself, and is positioned in the second holding state by the second positioning portion formed in itself, and therefore, the fuel cartridge can be reliably positioned in the first holding state and the second holding state.

Besides, according to the fuel cartridge of the present invention, the fuel cartridge is constructed by the rigid portion and the elastic portion, and the sharpened part of the fuel feeding pipe pierces the elastic portion. Therefore, leakage of the fuel after piercing can be prevented, and since the other portion is made the rigid body, rigidity of the fuel cartridge can be enhanced.

Further, according to the fuel cartridge of the present invention, the fuel cartridge is constructed to be of the double bag body structure, the fuel is sealed in the inner bag body, and the compressed air which applies the pressure to the inner bag body is sealed in the outer bag body. Therefore, the pressure of the compressed air in the outer bag body can be applied to the surface of the inner bag body substantially uniformly, and thereby, reliability of refueling is enhanced.

### BRIEF DESCRIPTION OF THE DRAWINGS

FIG. 1 a general perspective view showing a camera-equipped portable telephone of an embodiment;

FIG. 2 is a block diagram showing a construction of the camera-equipped portable telephone shown in FIG. 1;

FIG. 3 is an explanatory view showing a section of a fuel cartridge and a hinge shaft of the embodiment;

FIG. 4 is a sectional view showing a state in which the fuel cartridge is housed into the hinge shaft in FIG. 3;

FIG. 5 is a sectional view showing a state in which the fuel cartridge is completely housed in the hinge shaft in FIG. 3;

FIG. 6 is a sectional view of the hinge shaft showing a first position of a holding part;

FIG. 7 is a sectional view of the hinge shaft showing a second position of the holding part;

FIG. 8 is a sectional view showing a section of a fuel cartridge of another embodiment and the hinge shaft;

FIG. 9 is a sectional view showing a state in which the fuel cartridge is inserted into the hinge shaft in FIG. 8;

FIG. 10 is a sectional view showing a state in which the fuel cartridge is completely inserted in the hinge shaft in FIG. 8;

FIG. 11 is a sectional view showing a contracted action of the fuel cartridge in FIG. 8;

FIG. 12 is a schematic view showing another embodiment of a fuel supply section which supplies the fuel to a fuel cell;

FIG. 13 is a sectional view of a holding part in which the fuel cartridge is held in the first holding state by frictional resistance;

FIG. 14 is a sectional view of the holding part in which the fuel cartridge is held in the second holding state by the frictional resistance;

FIG. 15 is a sectional view showing another embodiment of the fuel supply device;

FIG. 16 is a sectional view showing another embodiment of the fuel supply device;

FIG. 17 is a sectional view showing another embodiment of the fuel supply device;

FIG. 18 is a perspective view of a camera showing one example of a camera in which the fuel cartridge is loaded; and

FIG. 19 is a flowchart showing a use method of the fuel cartridge in the camera shown in FIG. 18.

### DETAILED DESCRIPTION OF THE PREFERRED EMBODIMENTS

Preferred embodiments of a fuel-cell-equipped apparatus and a fuel cartridge of the present invention will be described in detail in accordance with the attached drawings hereinafter.

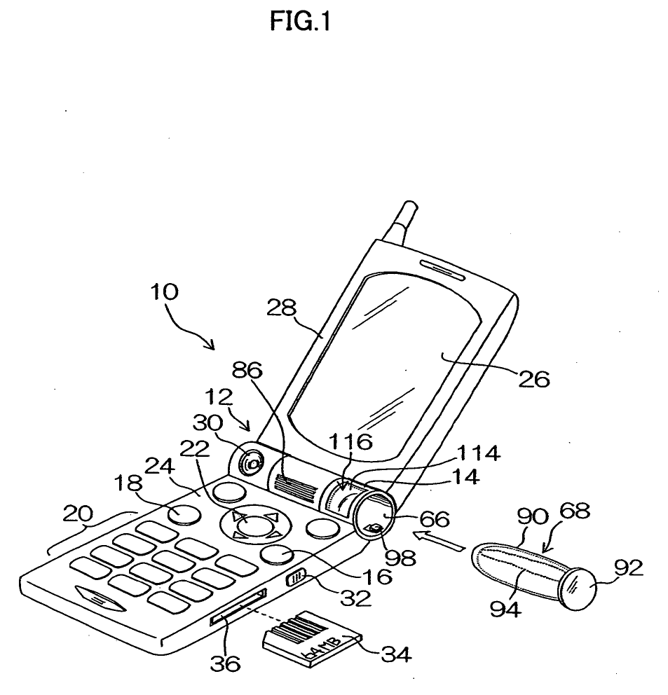

FIG. 1 is a general perspective view of a camera-equipped portable telephone 10 according to an embodiment to which the fuel-cell-equipped apparatus of the present invention is applied.

The camera-equipped portable telephone 10 shown in the drawing is a folding portable telephone in which a body 12 is folded to be openable and closable via a hinge shaft (hinge part) 14 at a central portion, and a fuel cell is mounted in a hollow portion of the hinge shaft 14. The fuel cell will be described later.

The body 12 of the camera-equipped portable telephone 10 is constructed by an operation section 24 on which various kinds of operation buttons such as a power supply button 16, a talk button 18, a dial button 20, and a cross button 22 which is a menu selecting button are exposed and a display section 28 on which a main display 26 is exposed when the body 12 is opened with the hinge shaft 14 as a center. The main display 26 is, for example, a transmission type TFT liquid crystal display with QVGA (Quarter Video Graphics Array: 240 by 320 dots) of about 2.2 inches, which displays an image with high definition in accordance with the number of pixels of a camera module 30 provided adjacently to the hinge shaft 14 is mounted. The camera module 30 is, for example, a camera such as a CCD, C-MOS or the like of one million pixels having an auto-focus function and an electronic zoom function of seven times at the maximum.

A sub display (not shown) is provided at a back surface of the display section 28. The sub display is, for example, a semitransmissive TFT liquid crystal display of about 1.1 inches (120 by 120 dots), where time, radio sensitivity and the like are displayed when the camera-equipped portable telephone 10 is in the talk mode, and an image which is picked up by the camera module 30 is displayed when it is switched to the camera mode from the talk mode. Switching of the talk mode and the camera mode is performed by operating the cross button 22 of the operation section 24.

At an image picking up time of the camera-equipped portable telephone 10, the main display 26 and the sub display of the display section 28 function as an electronic view finder when the camera-equipped portable telephone 10 is switched to the camera mode from the talk mode by the operation of the cross button 22. When the photographer performs a pressing operation of a release switch 32, a subject image taken by the camera module 30 is picked up, and the picked-up image is displayed on the main display 26 and the sub display as a static image. The image data of the picked-up subject image is recorded in an external memory slot 34 of 64 MB, for example, such as a memory stick and a memory card as an electronic data by a registration operation by the cross button 22. The release switch 32 and an insertion port 36 of the external memory slot 34 are adjacently disposed respectively on a side surface of the operation section 24.

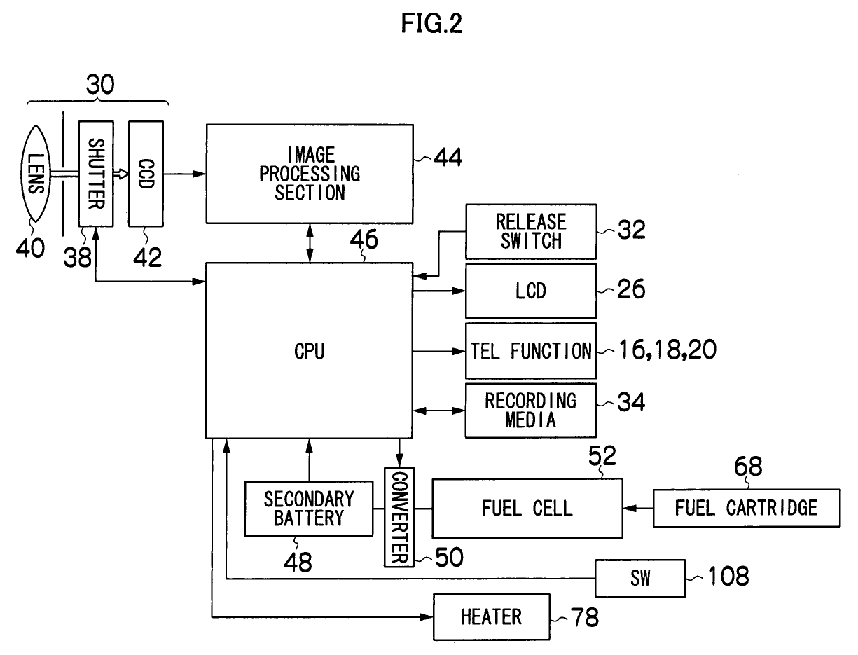

FIG. 2 is a block diagram showing a construction of the camera-equipped portable telephone 10.

According to the drawing, when the release switch 32 is pressed, a shutter 38 of the camera module 30 opens, subject light incident from the lens 40 is focused on an image formation surface of a CCD (or C-MOS) 42, and the optical data is converted into an electric image data. After the image data is image-processed by an image processing section 44, the image data is stored in the external memory slot 34 as the image data.

Each section constructing the camera-equipped portable telephone 10 is collectively controlled by a CPU 46. A secondary battery (battery) 48 is connected to the CPU 46, and each section constructing the camera-equipped portable telephone 10 is driven by the electric power charged in the secondary battery 48. The secondary battery 48 is detachably mounted to a back surface of the operation section 24.

The CPU 46 performs power generation of a fuel cell 52 by operating a converter 50 when the electric power charged in the secondary battery 48 becomes insufficient. Then, the electric power is supplied to the secondary battery 48 from the fuel cell 52 to charge the secondary battery 48. When the charge is completed, the CPU 46 stops the power generation of the fuel cell 52 by stopping the operation of the converter 50. The fuel cell 52 is mounted in the hollow portion of the hinge shaft 14 shown in FIG. 1 as described above.

Next, the fuel cell 52 will be described.

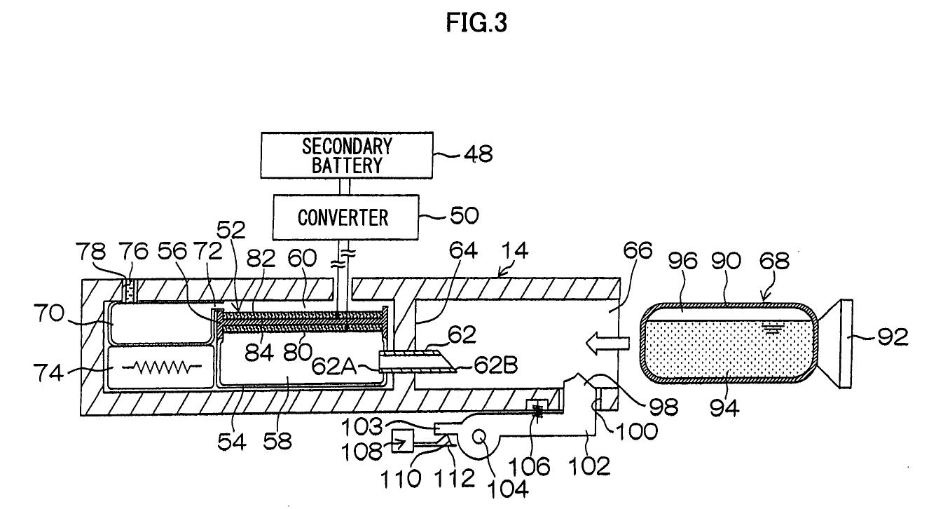

The fuel cell 52 of the embodiment is a direct methanol fuel cell, and a casing 54 of the fuel cell 52 is divided into a fuel chamber 58 and an air chamber 60 by a battery cell 56 as shown in FIG. 3. A base end part 62A of a fuel feeding pipe 62 constructing a fuel supply section is connected to the fuel chamber 58, a tip end part 62B of the fuel feeding pipe 62 is extensively provided in a cartridge holding chamber (holding section) 66 through a partition wall 64 formed inside the hinge shaft 14. The tip end part 62B of the fuel feeding pipe 62 is formed into a sharpened shape so as to be able to pierce a fuel cartridge 68 which will be described later. The cartridge holding chamber 66 is constructed integrally with the hinge shaft 14 by forming the hinge shaft 14 to be hollow as shown in FIG. 1, where the cylindrical cartridge holding chamber 66 is formed coaxially with the hinge shaft 14.

Meanwhile, a water storage part 70 is provided adjacently to the air chamber 60 as shown in FIG. 3. The water storage part 70 communicates with the air chamber 60 via a water discharge port 72. Thereby, water which is generated in the air chamber 60 is stored in the water storage part 70 via the water discharge port 72. The water stored in the water storage part 70 is heated by heat of a heater 74 adjacent to the storage part 70, then becomes water vapor and is released to outside air via a filter 76. The water storage part 70 and the heater 74 are housed in the hollow portion of the hinge shaft 14, and the filter 76 is attached in a through hole 78 formed in the hinge shaft 14. The heater 74 is also driven when the camera-equipped portable telephone 10 is used in a low-temperature environment. Namely, the fuel cell 52 usually cannot cause chemical reaction in a low-temperature environment at a below-freezing temperature or the like, but it causes chemical reaction and generates power by being heated by the heater 74. Accordingly, the one heater 74 provides the functions of the heater which vaporizes water and the heater which heats the fuel cell 52.

The battery cell 56 is constructed by a fuel electrode 80 which constructs a wall surface of the fuel chamber 58, an air electrode 82 which constructs a wall surface of the air chamber 60, and a proton conductive membrane 84 sandwiched by the fuel electrode 80 and the air electrode 82.

When a methanol solution (hereinafter called “fuel”) is supplied to the fuel chamber 58, and voltage is applied to the fuel electrode 80, the fuel is decomposed into carbon dioxide, ions of hydrogen and electrons by a catalytic reaction in the fuel electrode 80. The carbon dioxide is released to the outside air from the fuel chamber 58 via a gas-liquid separating filter (not shown) provided on the wall surface of the fuel chamber 58 and an air-vent hole (not shown) formed in the hinge shaft, and the ions of hydrogen pass through the proton conductive membrane 84 and move to the air electrode 82. The electrons flow to the secondary battery 48 by the converter 50, and thereby the secondary battery 48 is charged.

The ions of hydrogen which move to the air electrode 82 pass through the gas-liquid separating filter (not shown) provided on the wall surface of the air chamber 60, and thereafter, combine with oxygen and electrons which flow into the air chamber 60 via an air intake hole 86 (see FIG. 1) of the hinge shaft 14 to be water. The water is stored in the water storage part 70 via the water discharge port 72, and thereafter, becomes water vapor by the heat of the heater 74 as described above to be released to the outside air.

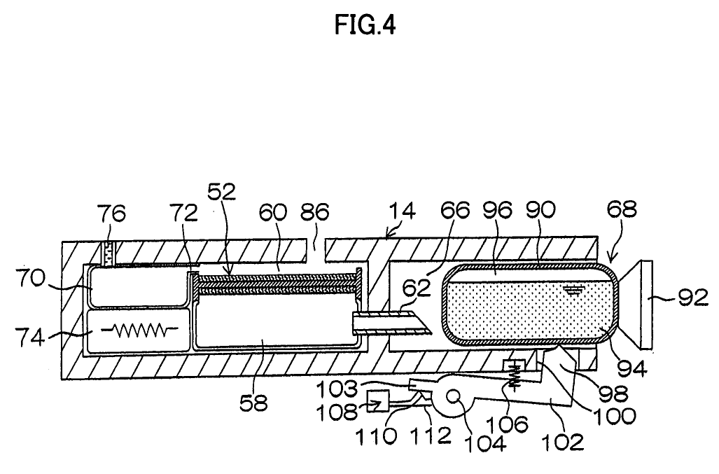

The fuel cartridge 68 is constructed by a substantially cylindrical cartridge body 90 and a cap 92. The cartridge body 90 is an extensible and contractible bag body made of an alcohol-resistant material such as Teflon rubber, is formed into a size capable of being housed in the cartridge holding chamber 66 as shown in FIG. 4, and has a fuel 94 that is the fuel and a compressed air 96 at a predetermined pressure sealed inside.

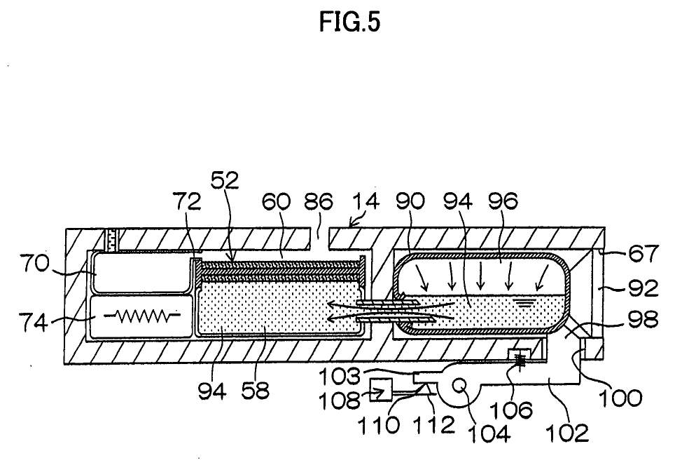

When the cartridge body 90 is completely housed in the cartridge holding chamber 66 as shown in FIG. 5, the cartridge body 90 is pierced by the tip end portion (sharpened portion) 62B of the fuel feeding pipe 62. By this operation, the fuel 94 sealed in the cartridge body 90 is pumped (supplied) to the fuel chamber 58 of the fuel cell 52 via the fuel feeding pipe 62 by the pressure of the compressed air 96. The cap 92 is formed into the size which is fitted into an open end portion 67 of the cartridge holding chamber 66 when the fuel cartridge 68 is completely housed in the cartridge holding chamber 66 as shown in FIG. 5. The cap 92 may be constructed to be a separate piece from the cartridge body 90. It is preferable to provide a check-valve in the fuel feeding pipe 62 and prevent backflow of the fuel 94 supplied to the fuel chamber 58 to the cartridge body 90. Further, in the case of the fuel cartridge in which only the fuel 94 is sealed, a pump is provided separately and the fuel 94 is supplied to the fuel chamber 58 by the pump.

Incidentally, the cartridge holding chamber 66 is provided with a lock claw 98 which prevents the fuel cartridge 68 from unexpectedly falling off from the cartridge holding chamber 66 as shown in FIG. 5. The lock claw 98 is disposed in an opening 100 which is formed in the cartridge holding chamber 66, is formed integrally with an arm 102 disposed outside the cartridge holding chamber 66, and is made capable of advancing and retreating with respect to the cartridge holding chamber 66 by the arm 102 being rotatably supported by the body 12 via a shaft 104. The lock claw 98 is biased in a direction to advance with respect to the cartridge holding chamber 66 as shown in FIG. 3 by a biasing force of a spring 106 attached to the hinge shaft 14 and the arm 102, and is made to abut on a base portion of the cartridge body 90 with a predetermined biasing force when the fuel cartridge 68 is completely housed in the cartridge holding chamber 66 as shown in FIG. 5. Thereby, the fuel cartridge 68 is prevented from slipping off unexpectedly. When the fuel cartridge 68 is removed from the cartridge holding chamber 66, by picking and extracting the cap 92, the lock claw 98 retreats from the cartridge holding chamber 66 against the biasing force of the spring 106 by the extracting force, and therefore, the fuel cartridge 68 can be removed from the cartridge holding chamber 66 without any problem.

A micro switch 108 is connected to the lock claw 98 via the arm 102. The micro switch 108 has a pair of contact pieces 110 and 112 which are turned ON/OFF by a projected part 103 which is provided to project at an end portion of the arm 102. Namely, as shown in FIGS. 3 and 5, the micro-switch 108 is turned ON by providing continuity between the contact pieces 110 and 112 by the contact piece 110 being pressed by the projected part 103, and is turned OFF by the projected part 103 retreating from the contact piece 110 as shown in FIG. 4 to provide discontinuity between the contact pieces 110 and 112. The ON/OFF signals of the micro-switch 108 are outputted to the CPU 46 shown in FIG. 2. The CPU 46 detects complete insertion of the fuel cartridge 68 by the ON signal from the micro-switch 108, and thereafter, inputs a power supply to each section which constructs the camera-equipped portable telephone 10. When the CPU 46 detects the OFF signal from the micro-switch 108 at the time of the power supply being turned ON of the camera-equipped portable telephone 10, namely, when the CPU 46 detects the fuel cartridge 68 being housed as shown in FIG. 4, it forcefully turns OFF the power supply of the camera-equipped portable telephone 10 in order to prevent the fuel 94 from being supplied at the time of the power supply being turned ON. The present invention is not limited to the signal from the micro-switch 108, and in the case of the cartridge holding chamber 66 having a lid, the CUP 46 may forcefully turn OFF the power supply of the camera-equipped portable telephone 10 when it detects an opening operation of the lid by a sensor.

An observation window 116 in which a transparent plastic plate 114 is fitted is formed at the hinge shaft 14 as shown in FIG. 1, and the residual amount of the fuel 94 in the cartridge body 90 can be visually recognized via the observation window 116. Thereby, when the fuel 94 in the cartridge body 90 is used up and the cartridge body 90 becomes completely empty of the fuel 94, the fuel cartridge 68 can be replaced with a new fuel cartridge 68.

According to the camera-equipped portable telephone 10 constructed as described above, the cartridge holding chamber 66 which holds the fuel cartridge 68 in which the fuel 94 to be supplied to the fuel cell 52 and the compressed air 96 are sealed is provided. When the fuel cell 52 is held in the cartridge holding chamber 66 and the fuel 94 sealed in the fuel cartridge 68 is supplied to the fuel cell 52 of the camera-equipped portable telephone 10, the supply of the fuel 94 is performed by rapidly pumping the fuel 94 via the fuel feeding pipe 62 by the pressure of the compressed air 96 which is similarly sealed in the fuel cartridge 68. Thereby, the fuel 94 can be supplied to the fuel cell 52 without providing a pump, and therefore, the compact and light camera-equipped portable telephone 10 can be provided.

According to the fuel cartridge 68 of the embodiment, the fuel 94 can be reliably supplied to the fuel cell 52 with the simple construction in which the fuel 94 and the compressed air 96 are only sealed in the cartridge body 90.

Further, according to the camera-equipped portable telephone 10, the cartridge holding chamber 66 is formed in the hollow portion of the hinge shaft 14 which is a dead space of the camera-equipped portable telephone 10, and therefore, the cartridge holding chamber 66 can be included in the camera-equipped portable telephone 10 without increasing the camera-equipped portable telephone 10 in size. If there is an allowance in a cylindrical space of the hinge shaft 14, a reserve tank may be formed between the fuel cell 52 and the cartridge holding chamber 66, and the fuel of the fuel cartridge 68 may be temporarily stored in the reserve tank and then supplied to the fuel cell 52.

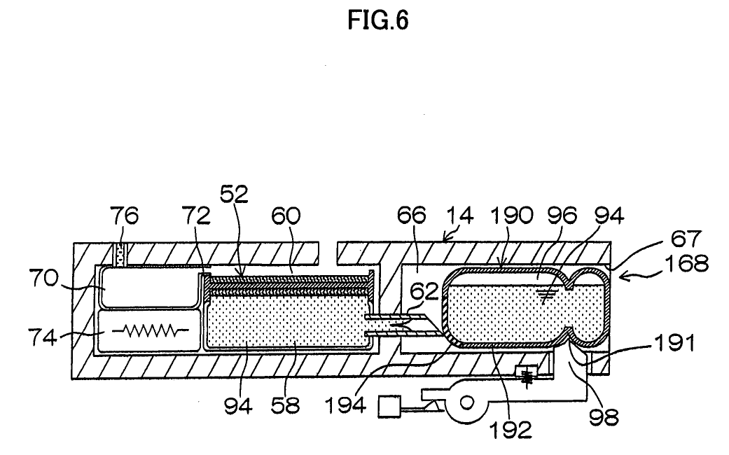

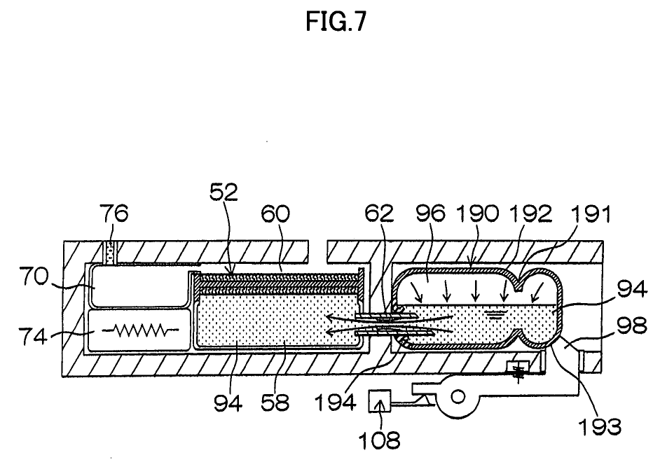

FIG. 6 is a sectional view showing a state in which a fuel cartridge 168 of another embodiment is held and positioned in a first holding state in the cartridge holding chamber 66 of the hinge shaft 14, and FIG. 7 is a sectional view showing a state in which the fuel cartridge 168 is held and positioned in a second holding state in the cartridge chamber 66.

A cartridge body 190 of the fuel cartridge 168 is constructed by a rigid member (rigid body portion) 192 of a transparent plastic or the like in most part of it, and a portion which is pierced by the fuel feeding pipe 62 is constructed by an elastic member (elastic body portion) 194 of rubber or the like.

In the first holding state shown in FIG. 6, the lock claw 98 is engaged with a constricted portion (first positioning portion) 191 formed at the cartridge body 190 of the fuel cartridge 168. In this first holding state, the fuel cartridge 168 is held in the position immediately before it is pierced by the fuel feeding pipe 62. The first holding state can be visually recognized by recognizing the insertion position of the fuel cartridge 168. In the second holding state shown in FIG. 7, the lock claw 98 is engaged with a rear end curved portion 193 of the cartridge body 190. In the second holding state, the fuel cartridge 168 is held in the state in which it is pierced by the fuel feeding pipe 62. The second holding state can be visually recognized by recognizing the insertion position of the fuel cartridge 168 and the lock claw 98.

According to the fuel cartridge 168 thus constructed, by holding and positioning the fuel cartridge 168 in the first holding state in FIG. 6, the fuel cartridge 168 can be held in the camera-equipped portable telephone 10 in the state in which the fuel cartridge 168 does not fall off the camera-equipped portable telephone 10 and the reserve fuel 94 is not supplied. When the residual amount of the secondary battery 48 runs out thereafter, and a battery warning light (not shown) which is provided at the camera-equipped portable telephone 10 is lit, the fuel 94 is supplied to the fuel cell 52. In this case, the fuel cartridge 168 is moved to the position of the second holding state in FIG. 7 from the position of the first holding state. By this movement, the elastic member 194 of the cartridge body 190 is pierced by the sharpened part 62B of the fuel feeding pipe, and therefore, the fuel 94 in the fuel cartridge 168 is pumped to the fuel cell 52 via the fuel feeding pipe 62 by the pressure of the compressed air 96. Thereby, the fuel 94 in the fuel cartridge 168 can be supplied to the fuel cell 52 by the extremely simple structure.

The shape of the cartridge body 190 may be changed so that it is difficult for the cartridge body to be housed in the cartridge holding chamber 66 from an opposite end portion, by making the end portion with the elastic member 194 thin and by making the diameter of the opposite end portion slightly larger than the diameter of the open end portion 67 of the cartridge holding chamber 66 so that the cartridge body 190 may be inserted with the elastic member 194 in the forefront. Namely, it is preferable to give the directional property of insertion to the fuel cartridge 168.

Furthermore, the portion which is pierced by the sharpened part 62B of the fuel feeding pipe 62 is made the elastic member 194, whereby it can be easily pierced by the sharpened part 62B, and after being pierced, the elastic member 194 closely contacts the outer peripheral surface of the fuel feeding pipe 62 by the elastic restoring force of the elastic member 194, thus making it possible to prevent leakage of the fuel 94. By making the other portion the rigid member 192, rigidity can be given to the fuel cartridge 168.

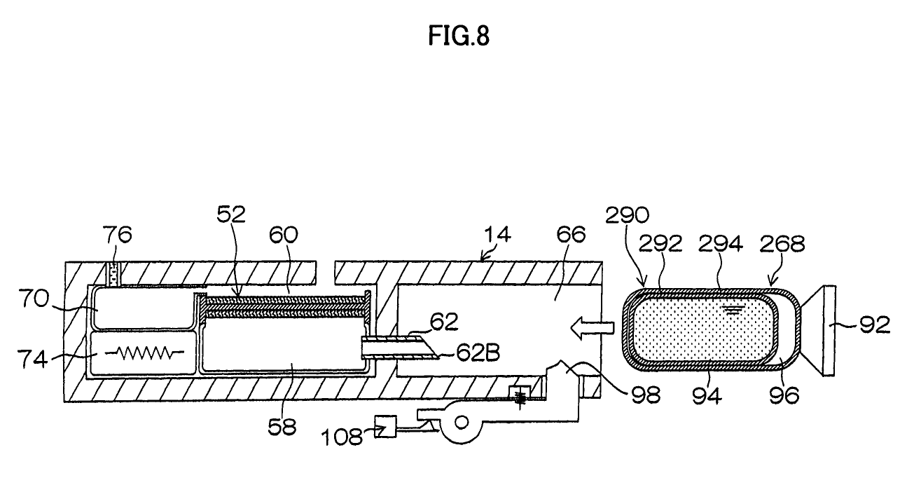

A fuel cartridge 268 of another embodiment is shown in FIGS. 8 to 11. A cartridge body 290 of this fuel cartridge 268 is constructed to be of a double bag body structure constituted of an inner bag 292 and an outer bag 294. The fuel 94 is sealed in the inner bag 292, and the compressed air 96 which gives pressure to the inner bag 292 is sealed in the outer bag 294.

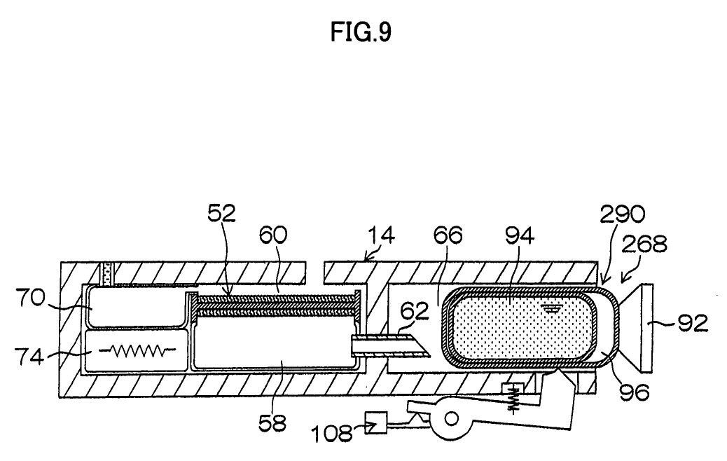

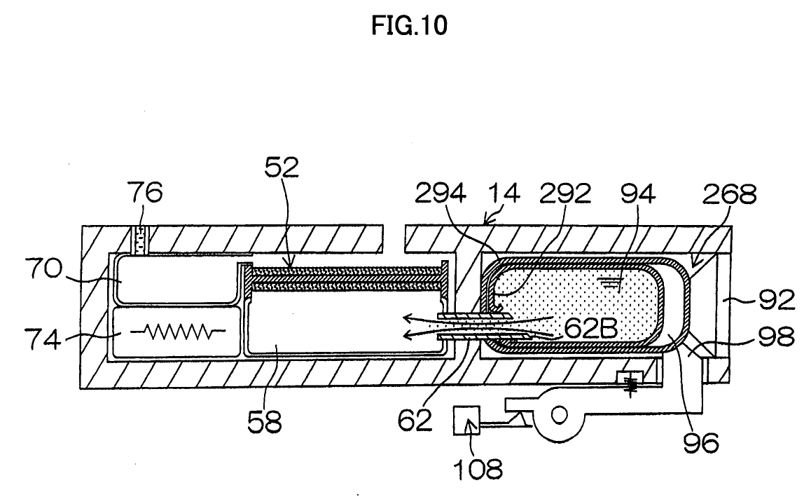

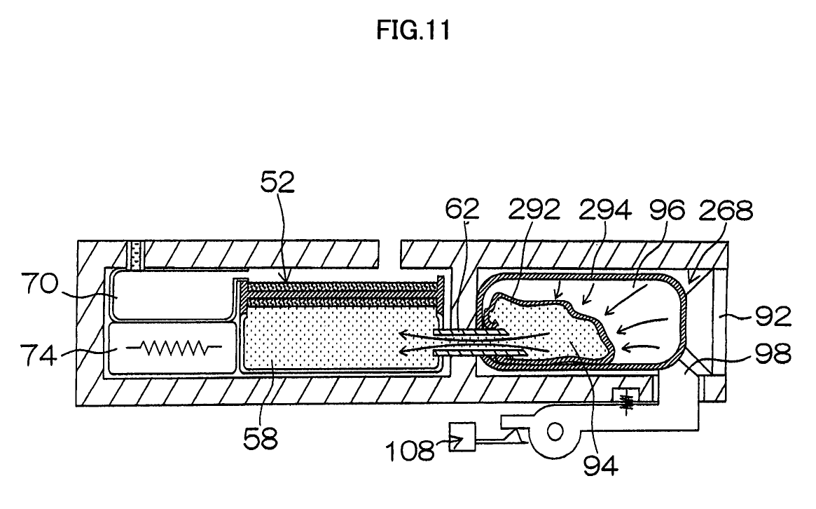

When this fuel cartridge 268 is inserted into the cartridge holding chamber 66 as shown in FIG. 9, and the sharpened part 62B of the fuel feeding pipe 62 is caused to pierce the inner bag 292 from the outer bag 294 as shown in FIG. 10, the fuel 94 sealed in the inner bag 292 is pushed out to the fuel feeding pipe 62 by the pressure of the compressed air 96 sealed in the outer bag 294, and is pumped to the fuel cell 52. By separately preparing the bag bodies 292 and 294 in which the fuel 94 and the compressed air 96 are sealed, the pressure of the compressed air 96 in the outer bag 294 can be applied to the surface of the inner bag 292 substantially uniformly as shown in FIG. 11, and therefore, reliability of refueling is enhanced.

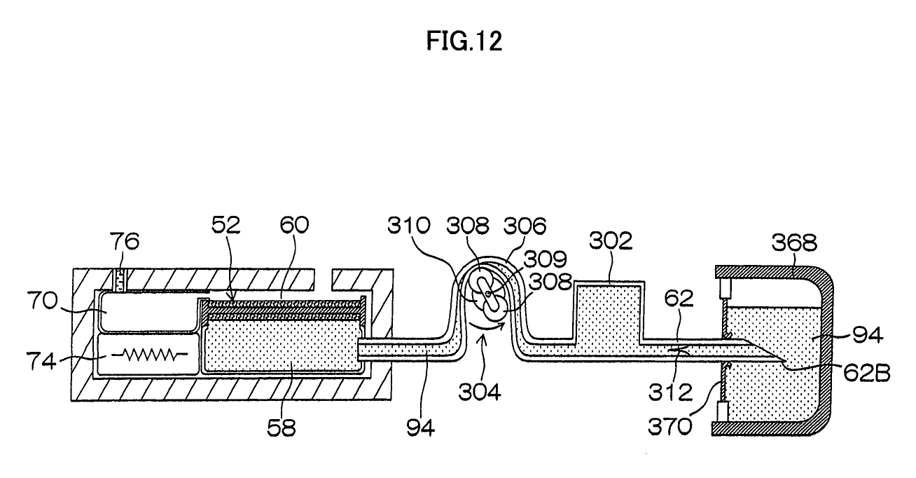

FIG. 12 is a schematic diagram showing another embodiment of a fuel supply device which supplies a fuel to the fuel cell 52. A fuel supply device 300 includes the fuel feeding pipe 62 at which the sharpening part 62B is formed, a buffer tank 302, a pump 304 and the like. The pump 304 is constructed by a pair of rollers 308 which deform a rubber tube 306 connecting the buffer tank 302 and the fuel cell 52 to pump the fuel 94 in the rubber tube 306 to the fuel cell 52, and a motor 310 which rotates these rollers 308 around a shaft 309.

When the elastic member 370 of a fuel cartridge 368 is pierced by the sharpened part 62B of the fuel feeding pipe 62, the pump 304 is driven. Thereby, the fuel 94 in the fuel cartridge 368 is sucked by the pump 304, and is stored in the buffer tank 302 from the fuel feeding pipe 62, after which the fuel 94 is supplied to the fuel cell 52 via the tube 306. The fuel 94 which is stored in the buffer tank 302 is prevented from flowing back by a check valve 312 provided inside the fuel feeding pipe 62.

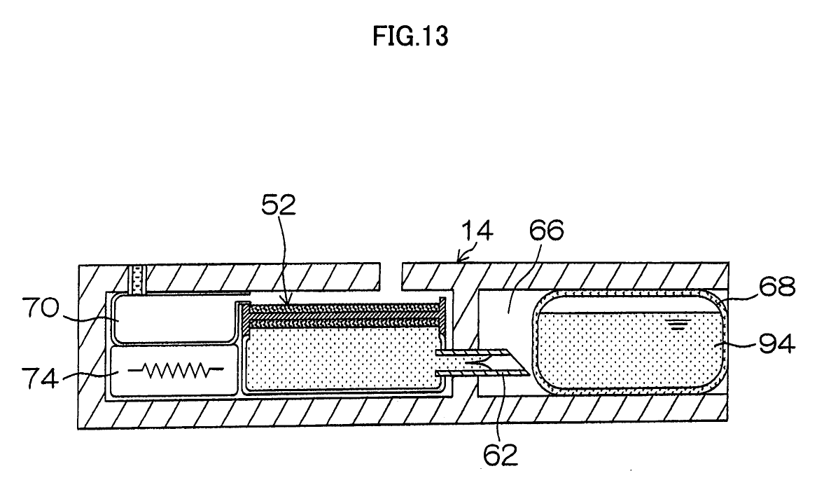

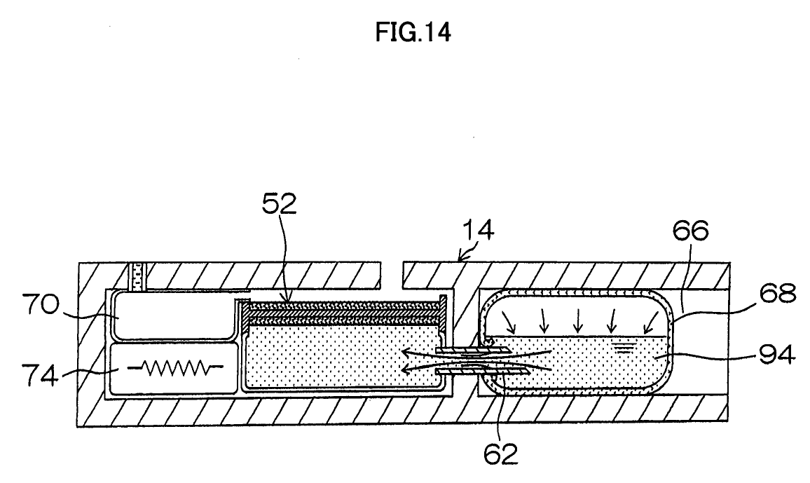

In FIGS. 6 and 7, the first holding state and the second holding state can be obtained by forming the lock claw 98 and the constricted portion 191 or the like at the fuel cartridge 168, but the present invention is not limited to this. As shown in FIG. 13, by bringing an outer peripheral surface of the fuel cartridge 168 into contact with an inner peripheral surface of the cartridge holding chamber 66, the fuel cartridge 168 may be held and positioned in the first holding state by the frictional resistance caused by this, and as shown in FIG. 14, the fuel cartridge 168 may be held and positioned in the second holding state by the above described frictional resistance. In this case, in order that the frictional resistance effectively occurs, it is preferable to form the inner peripheral surface of the cartridge holding chamber 66 and/or the outer peripheral surface of the fuel cartridge 68 into a pear skin form.

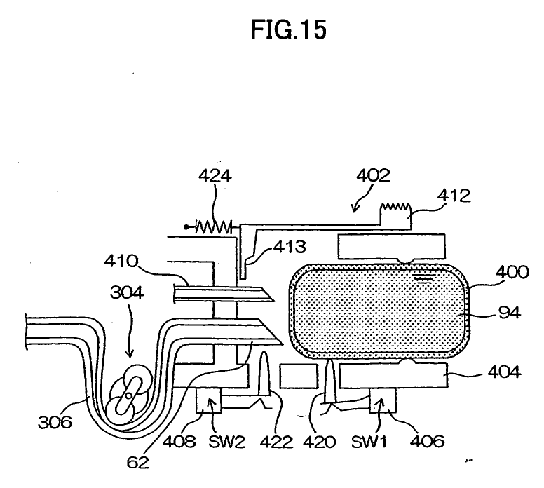

FIGS. 15 to 18 are sectional views showing one example of a fuel supply device 402 of a fuel cartridge 400 in which only the fuel 94 is sealed, and the same or similar members as or to those of the fuel supply device 300 shown in FIG. 12 are explained by being given the same reference numerals.

The fuel supply device 402 is constructed by a holding chamber 404 which holds the fuel cartridge 400, a switch 406 which detects that the fuel cartridge 400 is in the first holding state, a switch 408 which detects that the fuel cartridge 400 is in the second holding state, an air introducing pipe 410, an eject lever 412 for taking out the fuel cartridge and the like.

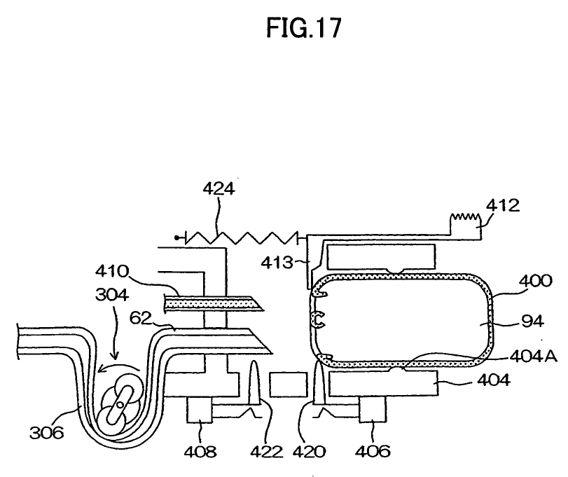

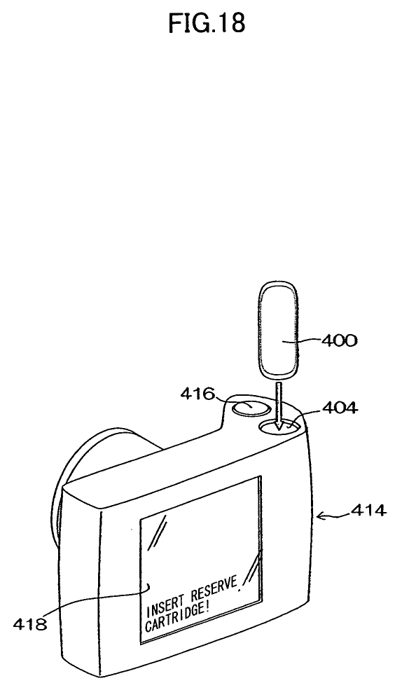

The holding chamber 404 is provided in the vicinity of a release button 416 on a top surface of a camera 414 as shown in FIG. 18, and a holding part 404A (see FIG. 17) which holds the fuel cartridge 400 is formed at an inner periphery of the holding chamber 404. The fuel cartridge 400 is taken in and out with respect to the holding chamber 404 from the top surface of the camera 414. At this time, the holding part 404A holds the fuel cartridge 400 by the frictional force. An LCD (display part) 418 is provided on a back surface of the camera 414, and the LCD 418 is utilized as a warning display.

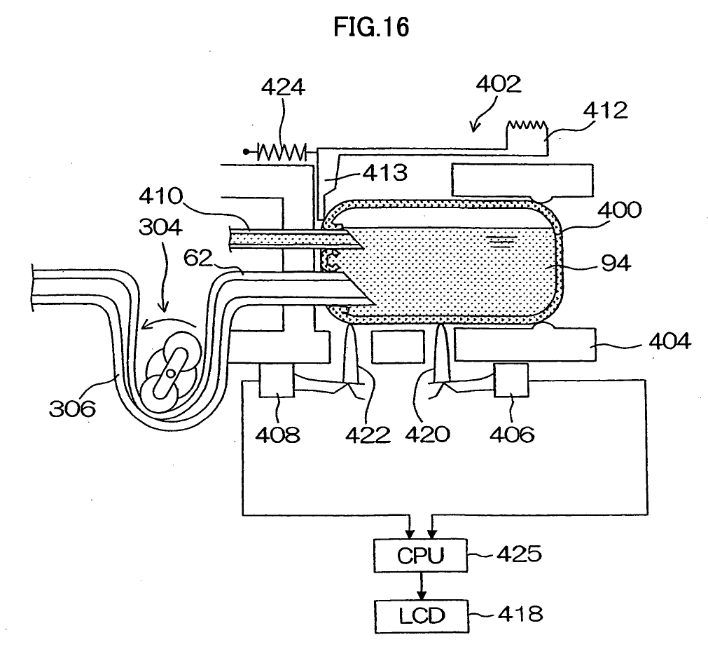

As shown in FIG. 15, the switch 406 is a switch which is closed by being depressed by a pin 420 when the fuel cartridge 400 is pushed into the holding part 402 and is in the first holding state. As shown in FIG. 16, the switch 408 is a switch which is closed by depressed by a pin 422 when the fuel cartridge 400 is further pushed in from the first holding state and is in the second holding state. ON/OFF signals of the switches 406 and 408 are outputted to a CPU (control unit) 425 shown in FIG. 16, and the CPU 425 selectively displays a message which is displayed on the LCD 418 based on the signals.

The air introducing pipe 410 is the pipe which is caused to pierce the fuel cartridge 400 with the fuel feeding pipe 62 and at the time of fuel sucking operation by the pump 304, introduces air in the same volume as this into the fuel cartridge 400.

The eject lever 412 is held in the position shown in FIGS. 15 and 16 by a biasing force of a spring 424, but when the fuel cartridge 400 is extracted from the holding part 402, the eject lever 412 is operated in an extracting direction against the biasing force of the spring 424 as shown in FIG. 17. Since a hook part 413 formed at an end portion of the eject lever 412 presses an end portion of the fuel cartridge 400 as a result, the fuel cartridge 400 is extracted from the air introducing pipe 410 and the fuel feeding pipe 62, and is extracted from the holding part 402.

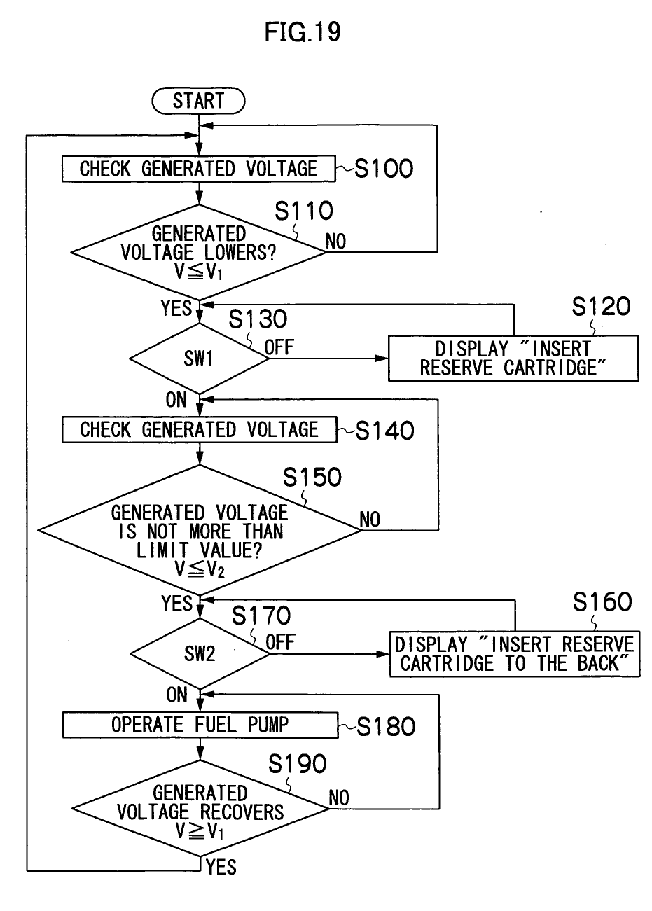

FIG. 19 is a flowchart showing one example of a method of using the fuel cartridge 400 in the camera 414 shown in FIG. 18.

First, in S (Step) 100, the operation state of the fuel cell such as generated voltage is checked. Next, when the generated voltage V lowers from a predetermined voltage (voltage at which the camera 414 can be stably operated) V1 in S110, or the residual amount of the fuel of the fuel cell becomes smaller than a predetermined amount, the CPU 425 in FIG. 16 causes the LCD 418 to display the message that “Insert the reserve fuel cartridge”, and performs warning display of insertion of the reserve fuel cartridge in S120. This message is displayed until the switch 406 is turned ON in S130. When the switch 406 is turned ON, namely, when the reserve fuel cartridge 400 is held in the first holding state as shown in FIG. 15, the CPU 425 erases the above described message from the LCD 418.

Next, the CPU 425 checks the operation state of the fuel cell such as generated voltage in S140. Next, when the generated voltage V lowers from a limit voltage (voltage at which the operation of the camera 414 becomes unstable) V2 in S150, the CPU 425 causes the LCD 418 to display the message that “push the reserve fuel cartridge to the back” in S160 to make warning display of the fuel supply operation of the reserve fuel cartridge. This message is displayed until the switch 408 is turned ON in S170. When the switch 408 is turned ON, namely, when the reserve fuel cartridge 400 is held in the second holding state as shown in FIG. 16, the CPU 425 erases the above described message from the LCD 418.

Next, in S180, the pump 304 in FIG. 15 is driven, and the fuel 94 of the fuel cartridge 400 is supplied to the fuel cell. This operation is continued until the generated voltage V rises to be higher than the predetermined voltage V1 in S190.

According to this flow, the inserting operation of the reserve fuel cartridge 400, and the fuel supply operation of the reserve fuel cartridge 400 can be smoothly performed.

In the embodiments, the camera-equipped portable telephone 10 is mainly described as the fuel-cell-equipped apparatus, but the fuel cell may be mounted on a multifunctional portable electronic communication apparatus such as an ordinary camera using a silver salt film, a digital camera or a PDA (Personal Digital Assistant), and a holding part which holds the fuel cartridge may be provided at the fuel-cell-equipped apparatus.

What is claimed is:

1. A fuel-cell-equipped apparatus equipped with a fuel cell, comprising:
a holding part which holds a fuel cartridge in which a fuel that is supplied to the fuel cell and compressed air are sealed.

2. A fuel-cell-equipped apparatus equipped with a fuel cell, comprising:
a holding part which holds a fuel cartridge in which a fuel that is supplied to the fuel cell is sealed,
wherein the holding part is capable of being in a first holding state holding the fuel cartridge in a position incapable of supplying the fuel to the fuel cell, and being in a second holding state holding the fuel cartridge in a position capable of supplying the fuel to the fuel cell.

3. A fuel-cell-equipped apparatus equipped with a fuel cell, comprising:
a holding part which holds a fuel cartridge in which a fuel that is supplied to the fuel cell is sealed,
wherein the holding part is provided in a hinge part of the fuel-cell-equipped apparatus.

4. The fuel-cell-equipped apparatus according to claim 1, further comprising:
a control unit which causes a display part to indicate that the fuel cartridge is required to be held to the holding part when generated voltage of the fuel cell lowers from a predetermined voltage, and causes the display part to indicate that the fuel of the fuel cartridge is supplied to the fuel cell when the generated voltage of the fuel cell lowers from a limit voltage.

5. The fuel-cell-equipped apparatus according to claim 1, further comprising:
a control unit which causes a display part to indicate that the fuel cartridge is required to be held to the holding part when the fuel in the fuel cell lowers from a predetermined amount, and causes the display part to indicate that the fuel of the fuel cartridge is supplied to the fuel cell when the fuel in the fuel cell lowers from an amount required at generating electrical power.

6. The fuel-cell-equipped apparatus according to claim 2, further comprising:
a control unit which causes a display part to indicate that the holding part is caused to hold the fuel cartridge when generated voltage of the fuel cell lowers from a predetermined voltage, and causes the display part to indicate that the fuel of the fuel cartridge is supplied to the fuel cell when the generated voltage of the fuel cell lowers from a limit voltage.

7. The fuel-cell-equipped apparatus according to claim 3, further comprising:
a control unit which causes a display part to indicate that the holding part is caused to hold the fuel cartridge when generated voltage of the fuel cell lowers from a predetermined voltage, and causes the display part to indicate that the fuel of the fuel cartridge is supplied to the fuel cell when the generated voltage of the fuel cell lowers from a limit voltage.

8. The fuel-cell-equipped apparatus according to claim 1,
wherein a fuel supply section is provided at the holding part of the fuel-cell-equipped apparatus, and
the fuel in the fuel cartridge is supplied to the fuel cell by the fuel supply section.

9. The fuel-cell-equipped apparatus according to claim 2,
wherein a fuel supply section is provided at the holding part of the fuel-cell-equipped apparatus, and
the fuel in the fuel cartridge is supplied to the fuel cell by the fuel supply section.

10. The fuel-cell-equipped apparatus according to claim 3,
wherein a fuel supply section is provided at the holding part of the fuel-cell-equipped apparatus, and
the fuel in the fuel cartridge is supplied to the fuel cell by the fuel supply section.

11. The fuel-cell-equipped apparatus according to claim 8,
wherein a fuel feeding pipe is provided at the fuel supply section of the fuel-cell-equipped apparatus, and
wherein a base end portion of the fuel feeding pipe is allowed to communicate with the fuel cell and a sharpened part which pierces the fuel cartridge is formed at a tip end portion of the fuel feeding pipe.

12. The fuel-cell-equipped apparatus according to claim 9,
wherein a fuel feeding pipe is provided at the fuel supply section of the fuel-cell-equipped apparatus, and
wherein a base end portion of the fuel feeding pipe is allowed to communicate with the fuel cell and a sharpened part which pierces the fuel cartridge is formed at a tip end portion of the fuel feeding pipe.

13. The fuel-cell-equipped apparatus according to claim 10,
wherein a fuel feeding pipe is provided at the fuel supply section of the fuel-cell-equipped apparatus, and
wherein a base end portion of the fuel feeding pipe is allowed to communicate with the fuel cell and a sharpened part which pierces the fuel cartridge is formed at a tip end portion of the fuel feeding pipe.

14. The fuel cartridge which is used for the fuel-cell-equipped apparatus according to claim 2,
wherein a first positioning portion for positioning the fuel cartridge in the first holding state, and a second positioning portion for positioning the fuel cartridge in the second holding state are formed.

15. The fuel cartridge which is used for the fuel-cell-equipped apparatus according to claim 11,
wherein the fuel cartridge is constructed by a rigid portion and an elastic portion, and the sharpened part of the fuel feeding pipe pierces the elastic portion.

16. The fuel cartridge which is used for the fuel-cell-equipped apparatus according to claim 12,
wherein the fuel cartridge is constructed by a rigid portion and an elastic portion, and the sharpened part of the fuel feeding pipe pierces the elastic portion.

17. The fuel cartridge which is used for the fuel-cell-equipped apparatus according to claim 13,
wherein the fuel cartridge is constructed by a rigid portion and an elastic portion, and the sharpened part of the fuel feeding pipe pierces the elastic portion.

18. The fuel cartridge which is used for the fuel-cell-equipped apparatus according to claim 11,
wherein the fuel cartridge is constructed to be of a double bag body structure, the fuel is sealed in an inner bag body, and compressed air which applies pressure to the inner bag body is sealed in an outer bag body.

19. The fuel cartridge which is used for the fuel-cell-equipped apparatus according to claim 12,
wherein the fuel cartridge is constructed to be of a double bag body structure, the fuel is sealed in an inner bag body, and compressed air which applies pressure to the inner bag body is sealed in an outer bag body.

20. The fuel cartridge which is used for the fuel-cell-equipped apparatus according to claim 13,
wherein the fuel cartridge is constructed to be of a double bag body structure, the fuel is sealed in an inner bag body, and compressed air which applies pressure to the inner bag body is sealed in an outer bag body.
